(19) United States
(12) Patent Application Publication
(10) Pub. No.: US 2026/0139097 A1
(43) Pub. Date: May 21, 2026

(54) SELF-HEALING MULTI-COMPONENT POLYIMIDE COMPOSITION AND FILM, AND METHOD FOR MANUFACTURING THE SAME

(71) Applicants: KOREA INSTITUTE OF SCIENCE AND TECHNOLOGY, Seoul (KR); INDUSTRY-ACADEMIC COOPERATION FOUNDATION, YONSEI UNIVERSITY, Seoul (KR)

(72) Inventors: Yong Chae JUNG, Wanju-gun (KR); Young Nam KIM, Wanju-gun (KR); Haksoo HAN, Seoul (KR); Ju Heon LEE, Seoul (KR)

(73) Assignees: KOREA INSTITUTE OF SCIENCE AND TECHNOLOGY, Seoul (KR); INDUSTRY-ACADEMIC COOPERATION FOUNDATION, YONSEI UNIVERSITY, Seoul (KR)

(21) Appl. No.: 18/697,371

(22) PCT Filed: Nov. 30, 2022
(86) PCT No.: PCT/KR2022/019154

§ 371 Date: Mar. 29, 2024

(30) Foreign Application Priority Data
Nov. 17, 2022 (KR) 10-2022-0154153

(51) Int. Cl. C08G 73/10

(52) U.S. Cl. CPC C08G 73/1042; C08G 73/1039

(57) ABSTRACT

The present disclosure provides a polyimide resin composition capable of repeated self-restoration, comprising a combination of multi-component polyimides and exhibiting excellent transparency and mechanical property, and a film comprising the polyimide resin composition. The film according to the present disclosure shows a self-restoring property that can self-heal a damage such as crack or shape deformation occurring at a room temperature, and can extend a life of the film and reuse it in virtue of repeatability of the self-restoring property. In the present disclosure, the polyimide resin composition can be used as an adhesive or a coating agent for electrical and electronic materials, and, for example, can be usefully used as a cover window for protecting the surface of a mobile device or a display device.

### TECHNICAL FIELD

The present disclosure relates to a multi-component polyimide composition and film, and a method for preparing the same.

### CROSS REFERENCE TO RELATED APPLICATION

The present application claims the priority of Korean Patent Application No. 10-2022-0154153 filed on Nov. 17, 2022, the entire contents of which is incorporated herein for all purposes by this reference.

### DESCRIPTION OF STATE-SPONSORED RESEARCH AND DEVELOPMENT

This research was conducted through the national project below:
Ministry name: Ministry of Science and ICT, Project management (specialized) organization and project executing institution name: Korea Institute of Science and Technology, Research project name: Operation cost support of Korea Research Institute of Science and Technology R&D, Research project name: Jeonbuk branch operation project, Project number: 2Z06690, Project identification number: 1711173313
Ministry name: Ministry of Science and ICT, Project management (specialized) organization: National Research Foundation of Korea, Project executing institution name: Korea Institute of Science and Technology, Research project name: Nanomaterial technology development, Research project name: Development of fully recyclable composite materials and eco-friendly recycling technology using multi-network-based dynamically bonded cross-linked polymers, Project number: 2021M3H4A1A03041343, Project identification number: 1711159628

### BACKGROUND ART

A self-healing material refers to a material that can easily and quickly restore a damaged area using external energy such as heat, light, or electricity when its property and lifespan are reduced due to physical damage. The self-healing is divided into an external method using external substances such as microcapsules, and an internal method in which a polymer detects and heals wounds by itself. The internal method is a method that detects and heals damage to the material itself, and has an advantage of enabling repeated healing through rapid exchange bond between molecules by reversible bond within a polymer or by entanglement and diffusion of polymer chains. However, the previously reported self-restoring materials have been used very limitedly due to a high temperature zone of enabling the self-healing, and the recently reported materials that can be used at a room temperature or 40-60° C. exhibit mechanical properties similar to a hydrogel or an elastomer, so there is a limit to their application range. A glass transition temperature of the polymer, where the polymer chains begin to move, must be controlled to lower its restoration temperature. In order to lower the glass transition temperature, the polymer structure must be designed flexibly to increase mobility of the polymer, which results in a disadvantage of having low mechanical properties.

Polyimide is a representative engineering plastic material with excellent heat resistance and chemical resistance as well as excellent mechanical property and electrical property. The polyimide began to be developed from the 1960s and is still used in various industrial fields such as an aerospace, an insulator, and an electronic device. Recently, Colorless polyimide (CPI) has been developed as an alternative material for a glass substrate (a liquid crystal). However, with the recent emphasis on the portability and wearable characteristic of the electronic device, there has been a demand for CPI-based display exterior materials that are highly transparent, bendable, and foldable. However, existing polyimide or colorless polyimide films suffer from functional limitation such as deterioration of physical properties and shortened lifespan due to repeated use and impact.

Fully aromatic polyimide mainly absorbs light around 550 nm, which is the visible light range, to give it a dark brown color and has a high glass transition temperature (200° C. or more) by inducing rigidity of the polymer chains, due to a charge transfer complex (CTC) between the chains within the polyimide molecule resulting from a conjugated system of pi electrons located in the main backbone. Since the strong rigidity of polyimide hinders mobility of the polymer chains, in order to develop polyimide as the self-restoring material, the mobility of the polyimide polymer chains must be increased to allow self-healing to proceed at a low temperature, simultaneously with reducing the mechanical properties.

In order to lower a glass transition temperature of the polyimide, research results have been reported using branched aliphatic diamine-based monomers that induce steric hindrance to design a structure with the glass transition temperature close to a room temperature. However, there was a limit to have the low mechanical property like the elastomer. Accordingly, a semi-aromatic polyimide structure was proposed through a combination of aliphatic diamine-based monomers containing an ether functional group and a disulfuric acid bond, but although such polyimide structure has a high mechanical property of 60 MPa or more while lowering the glass transition temperature to 100° C. or less, the polyimide structure has a disadvantage in that this mechanical property is lower than that of Kapton PI (fully aromatic structure polyimide), which is widely used commercially, and that the polymer structure still has a range of high healing temperature.

### DISCLOSURE

### Technical Problem

In an aspect, the present disclosure seeks to provide a polyimide-based resin composition having self-restoring property in a low temperature zone, a film comprising the same, and a method for preparing the same.

In an aspect, the present disclosure seeks to provide a polyimide-based resin composition having excellent transparency and mechanical property, a film comprising the same, and a method for preparing the same.

### Technical Solution

In order to achieve the above-described purposes, an embodiment according to the present disclosure provides a polyimide resin composition comprising:
a dianhydride-based monomer containing a trifluoromethyl group;
a dianhydride-based monomer containing an ether bond;
an aliphatic diamine-based monomer with a chain structure having 4 to 16 carbon atoms; and
an aromatic diamine-based monomer containing a disulfide bond;
wherein they are copolymerized with each other, and wherein the main backbone or side backbone of the polyimide resin comprises a hydrogen bond and a disulfide bond.

The other embodiment according to the present disclosure provides a polyimide film comprising the polyimide resin composition.

Another embodiment according to the present disclosure provides a method for preparing the polyimide resin composition, the method comprising the steps of:
adding an aliphatic diamine-based monomer with a chain structure of 4 to 16 carbon atoms, an aromatic diamine-based monomer containing a disulfide bond, a dianhydride-based monomer containing a trifluoromethyl group, and a dianhydride-based monomer containing a ether bond, into an organic solvent, and reacting them under an inert atmosphere to prepare a polyamic acid solution; and
carrying out imidization reaction of the polyamic acid solution to prepare the polyimide resin composition.

Still another embodiment according to the present disclosure provides a method for preparing a polyimide film, comprising the steps of:
preparing the polyimide resin composition; and
coating the prepared polyimide resin composition on a substrate.

### Advantage Effects

An embodiment of the present disclosure provides a polyimide resin composition capable of repeated self-restoration, comprising a combination of multi-component polyimides and exhibiting excellent transparency and mechanical property, and a film comprising the polyimide resin composition. The film according to the present disclosure shows a self-restoring property that can self-heal a damage such as crack or shape deformation occurring at a room temperature, and has technical advantages of extending a life of the film and enabling reuse it in virtue of repeatability of the self-restoring property.

In an embodiment of the present disclosure, the polyimide resin composition can be used as an adhesive or a coating agent for electrical and electronic materials, and, for example, can be usefully used as a cover window for protecting the surface of a mobile device or a display device.

### DESCRIPTION OF THE DRAWINGS

FIG. 1 is a schematic diagram of the synthesis steps used in Preparation Example 1.

FIG. 2 is a graph showing the results of a gel permeation chromatography of the compositions of Examples 1 to 5 according to embodiments of the present disclosure.

FIG. 3 is a graph showing FT-IR spectra of the compositions of Examples 1 to 5 according to embodiments of the present disclosure.

FIG. 4 is images taken with an optical microscope, showing the degree of self-healing at Tg+10° C., Tg+20° C., and Tg+30° C., based on the glass transition temperature (Tg) of each of Examples 6 to 10, after scratching the films of Examples 6 to 10 in Test Example 2.

FIG. 5 is a graph showing curves of stress-strain after self-healing according to Examples 6 to 10 (Tg+10° C., 20 minutes).

FIG. 6 is a graph showing curves of stress-strain after self-healing according to Examples 6 to 10 (Tg+20° C., 20 minutes).

FIG. 7 is a bar graph comparing the self-healing rates (%) of Examples 6 to 10.

FIG. 8 is a graph showing a time-temperature superposition (TTS) plot of the self-healing dynamic behavior of Example 9.

FIG. 9 shows an Arrhenius plot of transition temperatures as a function of frequency steps for Examples 6-10.

FIG. 10 is a bar graph showing comparison of activation energy as the self-healing dynamic behavior of Examples 6 to 10.

FIG. 11 is a diagram showing analysis of polymer chain mobility according to the ratios of two types of dianhydrides in Examples of the present disclosure.

FIG. 12 is a graph showing the XRD profiles of Examples 6 to 10 and Comparative Example 1.

FIG. 13 is a diagram schematically showing the intermolecular distance in Examples 6, 7, 9, and 10.

FIG. 14 is a diagram showing the 2D pattern of WAXD in Example 6.

FIG. 15 is a diagram showing the 2D pattern of WAXD in Example 10.

FIG. 16 is a diagram showing an image taken of the result of applying repeated bending according to Example 9.

FIG. 17 is a diagram showing an image taken of the result of applying repeated bending according to Comparative Example 1.

FIG. 18 is a graph showing the results of comparing the tensile test according to Example 9 and Comparative Example 1.

FIG. 19 is a graph comparing the mechanical properties of the film according to Example 9 and the film according to Example 11 which was prepared by dissolving and recycling the film of Example 9.

### MODE FOR INVENTION

Hereinafter, embodiments of the present disclosure will be described in more detail.

The embodiments of the present disclosure disclosed herein are illustrative only for the purpose of explanation, and the embodiments of the present disclosure may be implemented in various forms and should not be construed as being limited to the embodiments described in this specification. The present disclosure can be subjected to various modifications and may take various forms. The embodiments are not intended to limit the present disclosure to a specific description form, and should be understood as covering all modifications, equivalents, or substitutes fallen within the spirit and technical scope of the present disclosure.

Singular expressions include plural expressions unless the context clearly dictates otherwise. In this application, terms such as “comprise” or “have” are intended to designate the existence of features, numbers, steps, operations, components, parts, or combinations thereof described in the specification, but should not be understood that they exclude in advance the existence or addition of one or more other features, numbers, steps, operations, components, parts, or combinations thereof.

An embodiment of the present disclosure can provide a polyimide resin composition comprising:
a dianhydride-based monomer containing a trifluoromethyl group;
a dianhydride-based monomer containing an ether bond;
an aliphatic diamine-based monomer with a chain structure having 4 to 16 carbon atoms; and
an aromatic diamine-based monomer containing a disulfide bond;
wherein they are copolymerized with each other, and
wherein the main backbone or side backbone of the polyimide resin comprises a hydrogen bond and a disulfide bond.

Conventional multi-component polyimide resin composition had secured transparency by comprising a high content of CF₃ through 4,4′-(hexafluoroisopropylidene)diphthalic anhydride (6FDA), but had a disadvantage in that the main backbone became rigid due to the high repulsion between polymer chains by the trifluoromethyl group (—CF₃). However, it can be expected from an embodiment of the present disclosure that a content of the trifluoromethyl group (—CF₃) is reduced by adding a dianhydride-based monomer comprising an ether bond, thereby reducing the repulsion between the polymer chains and having more aromatic structures so that polyimide has higher mechanical property compared to that of the prior art. In addition, it is possible to rotate the polymer chains through the ether bond (—O—), which further increases flexibility of the chains while maintaining transparency, and can increase possibility of the interaction between the polymers upon self-healing by reducing a intermolecular distance between the polymer chains.

In this specification, the term ‘self-restoring property’ is used in the same meaning as self-healing property, and refers to a characteristic material that can easily and quickly restore a damaged area using external energy such as heat, light, or electricity when the property and lifespan of a material are reduced due to its physical damage. The self-restoring property or self-healing in this specification comprises both of an external method using external substances and an internal method in which a polymer detects and heals a damage by itself, and specifically may comprise rapid exchange bond between molecules by reversible bond within the polymer or the entanglement and diffusion of the polymer chains. Further, in an embodiment of the present disclosure, the self-restoring property or self-healing may comprise repetitive restoration or healing.

Existing polyimide materials with the self-restoring property have a problem in that they have a high glass transition temperature (Tg) of 200° C. or higher or show deterioration in the mechanical property when they have a low glass transition temperature, making practical application difficult. However, an embodiment of the present disclosure can provide a novel multi-component polyimide resin composition having a high mechanical property while exhibiting excellent self-restoring property at a low glass transition temperature by further comprising a dianhydride-based monomer containing an ether bond such that the resin composition has the mechanical property and flexibility of the polymer material simultaneously enhanced in a trade-off relationship.

As an embodiment, the dianhydride-based monomer containing the ether bond may comprise one or more selected from the group consisting of 4,4′-(4,4′-isopropylidenediphenoxy)diphthalic anhydride (BISPDA) and oxydiphthalic dianhydride (ODPA).

As an embodiment, the dianhydride-based monomer containing the trifluoromethyl group may be 4,4′-(hexafluoroisopropylidene)diphthalic anhydride (6FDA).

The 4,4′-(4,4′-isopropylidenediphenoxy)diphthalic anhydride (BISPDA) according to an embodiment has may be a compound represented by Formula 1 below:

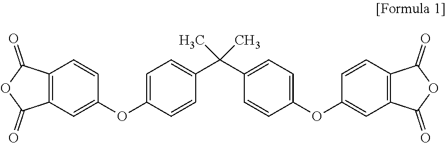 [SMILES: CC(C)(c1ccc(Oc2ccc3c(c2)C(=O)OC3=O)cc1)c1ccc(Oc2ccc3c(c2)C(=O)OC3=O)cc1]

The 4,4′-(hexafluoroisopropylidene)diphthalic anhydride (6FDA) according to an embodiment may be a compound represented by Formula 2 below:

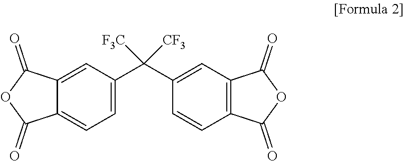 [SMILES: O=C1OC(=O)c2cc(C(c3ccc4c(c3)C(=O)OC4=O)(C(F)(F)F)C(F)(F)F)ccc21]

As an embodiment, the aliphatic diamine-based monomer may comprise one or more selected from the group consisting of 4,7,10-trioxa-1,13-tridecanediamine (TTDA), hexamethylenediamine, octamethylenediamine, decamethylenediamine, 2-methylpentamethylenediamine, 2-ethyltetramethylenediamine, 2-methyloctamethylenediamine, and trimethylhexamethylenediamine.

Specifically, the aliphatic diamine-based monomer may be 4,7,10-trioxa-1,13-tridecanediamine (TTDA), and the TTDA may be a compound represented by Formula 3 below:

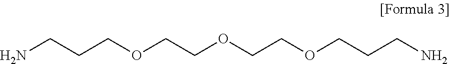 [SMILES: NCCCOCCOCCOCCCN]

As an embodiment, the aromatic diamine-based monomer may comprise one or more selected from the group consisting of 4,4′-dithioaniline (4AD), 2,2′-dithioaniline, 2-hydroxyl disulfide, 3,3′-dithiodipropionic acid, 2,2′-(dithiodimethylene)difuran, 4-aminophenyl disulfide, 2,2′-diaminodiethyl disulfide dihydrochloride, and 3,3′-dihydroxydiphenyl disulfide. Specifically, the aromatic diamine-based monomer may be one or more selected from the group consisting of 4,4′-dithioaniline, 2,2′-(dithiodimethylene)difuran, and 2,2′-diaminodiethyl disulfide dihydrochloride. More specifically, the aromatic diamine-based monomer may be 4,4′-dithioaniline (4AD) from the viewpoint of improving high dispersibility and mechanical property upon copolymerization, and the 4AD may be a compound represented by Formula 4 below:

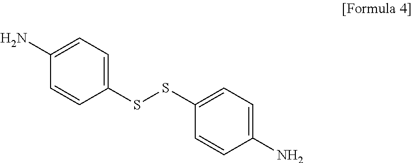 [SMILES: Nc1ccc(SSc2ccc(N)cc2)cc1]

As an embodiment, the composition may be a polyimide resin composition in which the four components of 4,4′-(4,4′-isopropylidene diphenoxy)diphthalic anhydride (BISPDA), 4,4′-(hexafluoroisopropylidene) diphthalic anhydride (6FDA), 4,7,10-trioxa-1,13-tridecanediamine (TTDA) and 4,4′-dithioaniline (4AD) are copolymerized from the perspective of providing excellent self-restoring property at a low temperature by exhibiting a low glass transition temperature while having high light transmittance and mechanical property in the zone of visible light.

The polyimide resin composition in which the above four components are copolymerized according to an embodiment may comprise a repeating unit represented by Formula 5 below. Specifically, the composition may have a polymerization degree of 3.48 to 31.39, based on the repeating unit below:

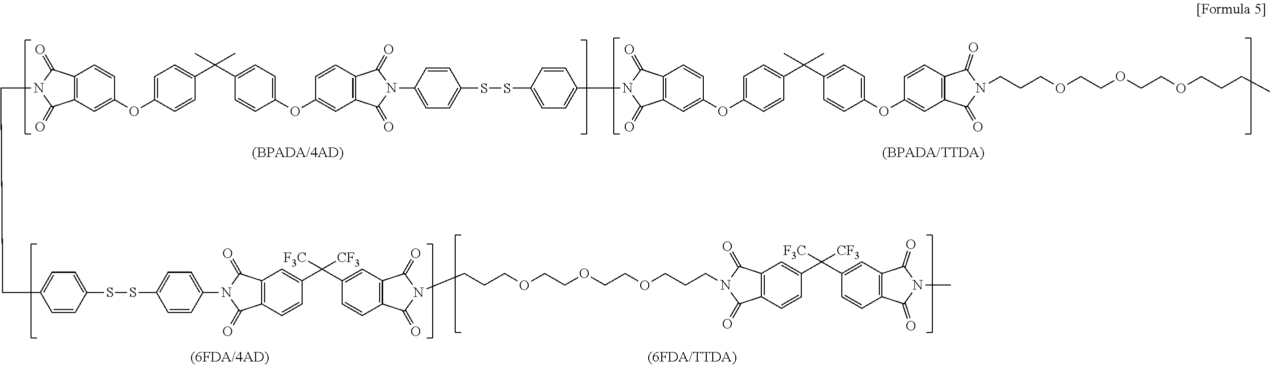

From the viewpoint of providing self-restoring property at a low temperature by having a low glass transition temperature along with high mechanical property and transparency, in the composition according to an embodiment, a sum of the aliphatic diamine-based monomer and the aromatic diamine-based monomer relative to a sum of the two dianhydride-based monomers, that is, the dianhydride-based monomer containing the trifluoromethyl group and the dianhydride-based monomer containing the ether bond may be copolymerized in molar ratio of 10:5 to 15. Specifically, the molar ratio of the sum of the aliphatic diamine-based monomer and the aromatic diamine-based monomer relative to the sum of the two dianhydride-based monomers may be 10:5 or more, 6 or more, 7 or more, 8 or more, 9 or more, 10 or more, 11 or more, 12 or more, 13 or more, or 14 or more, and may be 15 or less, 14 or less, 13 or less, 12 or less, 11 or less, 10 or less, 9 or less, 8 or less, 7 or less, or 6 or less.

As an embodiment, from the viewpoint of the composition for providing high self-restoring property at a low glass transition temperature while having excellent mechanical property, a molar ratio of the dianhydride-based monomer containing the ether bond and the dianhydride-based monomer containing the trifluoromethyl group may be 9:1 to 1:9. As an embodiment, the dianhydride-based monomer containing the ether bond may be copolymerized in an amount of 10 to 90 mol %, based on the total mol % of the two dianhydride-based monomers. Specifically, in the polyimide resin composition, the dianhydride-based monomer containing the ether bond may be copolymerized in an amount of 10 mol % or more, 15 mol % or more, 20 mol % or more, 25 mol % or more, 30 mol % or more, 35 mol % or more, 40 mol % or more, 45 mol % or more, 50 mol % or more, 55 mol % or more, 60 mol % or more, 65 mol % or more, 70 mol % or more, 75 mol % or more, 80 mol % or more, 85 mol % or more, or 90 mol % or more, based on the total mol % of the two dianhydride-based monomers, and may be copolymerized in an amount of 90 mol % or less, 85 mol % or less, 80 mol % or less, 75 mol % or less, 70 mol % or less, 65 mol % or less, 60 mol % or less, 55 mol % or less, 50 mol % or less, 40 mol % or less, 30 mol % or less, or 20 mol % or less, based on the total mol % of the two dianhydride-based monomers. If the dianhydride-based monomer containing the ether bond is out of the above range, either the mechanical property or the transparency may be reduced due to a lack of flexible bonding through the ether bond. Further, since a sufficient degree of polymerization is not secured, it may be difficult for the above composition to secure a molecular weight above a certain level and mold the composition into a film.

As an embodiment, the aliphatic diamine-based monomer and the aromatic diamine-based monomer in the composition may be copolymerized at a molar ratio of 2 to 8:1. Specifically, the molar ratio of the aliphatic diamine-based monomer to the aromatic diamine-based monomer may be 1:2 or more, 1:3 or more, 1:4 or more, 1:5 or more, 1:6 or more, or 1:7 or more, and may be 1:8 or less, 1:7 or less, 1:6 or less, 1:5 or less, 1:4 or less, or 1:3 or less. If the molar ratio is out of the above range, the self-restoring property may be decreased due to a disulfide bond (S—S), or the glass transition temperature may be risen due to increase in an aromatic ring group.

As an embodiment, the polyimide resin composition may have a weight average molecular weight of 10,000 to 100,000 g/mol. Specifically, the weight average molecular weight may be 10,000 g/mol or more, 11,000 g/mol or more, 12,000 g/mol or more, 15,000 g/mol or more, 20,000 g/mol or more, 25,000 g/mol or more, 30,000 g/mol or more, 40,000 g/mol or more, 50,000 g/mol or more, 60,000 g/mol or more, 70,000 g/mol or more, 80,000 g/mol or more, or 90,000 g/mol or more, and may be 100,000 g/mol or less, or 90,000 g/mol or more, 85,000 g/mol or less, 80,000 g/mol or less, 75,000 g/mol or less, 70,000 g/mol or less, 65,000 g/mol or less, 60,000 g/mol or less, 55,000 g/mol or less, 50,000 g/mol or less, 45,000 g/mol or less, 40,000 g/mol or less, 35,000 g/mol or less, 30,000 g/mol or less, 25,000 g/mol or less, 20,000 g/mol or less, or 15,000 g/mol or less. As an embodiment, the polyimide resin composition may have a polydispersity index (PDI) of 3 or less. Specifically, the polydispersity index may be 1.5 to 3. More specifically, the polydispersity index may be 1.5 or more, 2 or more, 2.1 or more, 2.2 or more, 2.3 or more, or 2.4 or more, and may be 3 or less, 2.6 or less, 2.5 or less, 2.4 or less, or 2.3 or less. If the composition is outside the above-mentioned ranges of the weight average molecular weight and the polydispersity index, the mechanical property may be deteriorated, or the transparency and the self-restoring property may be deteriorated.

As an embodiment, the present disclosure can provide a polyimide film comprising the polyimide resin composition. In this case, the constitutive components of the polyimide resin composition is as described above.

As an embodiment, the film may further comprise a substrate onto which the polyimide resin composition is applied. Specifically, the substrate may comprise one or more of a ceramic, a polymer, and a metal, but is not limited thereto. For example, the ceramic may comprise a glass, a silicon wafer, etc. The polymer may comprise polyimide-based, polyurethane-based, polyester-based, polystyrene-based, polyethylene-based, polyethylene terephthalate, etc. For example, the metal may comprise aluminum, iron, nickel, stainless steel, metal alloy, etc.

As an embodiment, a thickness of the polyimide film is not limited, but may be, for example, 1 to 100 μm. Specifically, the thickness of the polyimide film may be 1 μm or more, m or more, 20 μm or more, 30 μm or more, 40 μm or more, 50 μm or more, 60 μm or more, 70 μm or more, 80 μm or more, 90 μm or more, or 100 μm or more, and may be 100 μm or less, 90 μm or less, 80 μm or less, 70 μm or less, 60 μm or less, 50 μm or less, 40 μm or less, m or less, 20 μm or less, or 10 μm or less.

As an embodiment, the polyimide film may have a light transmittance of 90% or more at a wavelength range of 450 to 800 nm, based on a film thickness of 30 μm. Specifically, the light transmittance may be 91% or more, 92% or more, 93% or more, 94% or more, 95% or more, 96% or more, or 97% or more.

The film according to an embodiment of the present disclosure comprises the multi-component polyimide resin composition as described above, thereby exhibiting excellent mechanical strength while having flexibility that does not tear even during repeated bending, and at the same time, not only being self-restoration possible through entanglement of the polymer chains without using a separate external stimulus source (heat, light, etc.), but also enabling of lowering the self-restoring temperature range to about 100° C.

From the above viewpoint, the polyimide film according to an embodiment may exhibit a self-restoring rate of 75% or more at a temperature of 80 to 120° C. Specifically, the self-restoring temperature may be 80° C. or higher, 85° C. or higher, 90° C. or higher, 95° C. or higher, 100° C. or higher, 105° C. or higher, 110° C. or higher, or 115° C. or higher, and may be 120° C. or lower, 115° C. or lower, 110° C. or lower, 105° C. or lower, 100° C. or lower, 95° C. or lower, or 90° C. or lower. Specifically, the self-restoring rate may be 75% or more, 80% or more, 85% or more, 90% or more, or 95% or more. As an embodiment, the polyimide film may have a tensile strength of 50 MPa or more, 55 MPa or more, 60 MPa or more, 65 MPa or more, or 70 MPa or more. As an embodiment, the polyimide film may have an elastic modulus of 2,000 MPa or more, 2,100 MPa or more, 2,200 MPa or more, or 2,300 MPa or more.

As an embodiment, the film may exhibit antifouling and/or antibacterial properties.

As an embodiment, the film may be a coating film or an adhesive film. As an embodiment, the film may be a film for protecting a display surface. Specifically, the film may be a film for a display cover window.

As an embodiment, the present disclosure can provide an electronic device comprising the polyimide film. As an embodiment, the electronic device may be any one selected from a display, a semiconductor, a transistor, a light-emitting diode, and a laser device, but is not limited thereto.

Additionally, as an embodiment, the present disclosure can provide a method for preparing the polyimide resin composition as described above. Specifically, the method comprises the steps of adding an aliphatic diamine-based monomer with a chain structure of 4 to 16 carbon atoms, an aromatic diamine-based monomer containing a disulfide bond, a dianhydride-based monomer containing a trifluoromethyl group, and a dianhydride-based monomer containing an ether bond, into an organic solvent, and reacting them under an inert atmosphere to prepare a polyamic acid solution; and carrying out imidization reaction of the polyamic acid solution to prepare the polyimide resin composition.

According to an embodiment, a range of the molar ratio and a specific type of the aliphatic diamine-based monomer having the chain structure of 4 to 16 carbon atoms, the aromatic diamine-based monomer containing the disulfide bond, the dianhydride-based monomer containing the trifluoromethyl group, and the dianhydride-based monomer containing the ether bond are equally applicable to those of the polyimide resin composition described above.

As an embodiment, the organic solvent may be one or more selected from the group consisting of N,N-dimethylacetamide, N-methylpyrrolidone, N,N-dimethylformamide, N-vinylpyrrolidone, N-methylcaprolactam, dimethylsulfoxide, tetramethylurea, pyridine, dimethylsulfone, hexamethylsulfoxide, meta-cresol, gamma-butyrolactone, ethylcellosolve, butylcellosolve, ethylcarbitol, butylcarbitol, ethylcarbitol acetate, butylcarbitol acetate, ethylene glycol, ethyl lactate, butyl lactate, cyclohexanone, and cyclopentanone, but is not limited thereto.

As an embodiment, the inert atmosphere may be an atmosphere into which one or more inert gases selected from the group consisting of nitrogen, argon, hydrogen, helium, neon, xenon, and krypton are supplied, without being limited thereto. Specifically, the inert gas may be nitrogen.

As an embodiment, the step of preparing the polyamic acid solution may comprise reacting the four monomers in the organic solvent at −5 to 5° C. for 30 minutes to 2 hours, and then them stirring at 20 to 25° C. for 10 to 14 hours.

As an embodiment, the step of performing the imidization reaction may comprise adding an imidization catalyst and a dehydrating agent to the polyamic acid solution.

Specifically, the imidization catalyst may be one or more of pyridine, isoquinoline, and beta-picoline. Specifically, the dehydrating agent may comprise acetic anhydride.

As an embodiment, the imidization reaction may be performed at 40 to 60° C. for 5 to 15 hours.

An embodiment of the present disclosure can provide a method for preparing a polyimide film comprising the steps of preparing the polyimide resin composition according to the method described above; and coating the prepared polyimide resin composition on a substrate.

As an embodiment, the coating is not limited to the above step as long as the composition of the present disclosure can be coated on the substrate, and may be carried out, for example, by a bar coating, a spin-coating, a dip-coating, a drop-casting, a gravure roll coating, or an inkjet printing.

### Mode for Implementing the Invention

Hereinafter, the present disclosure will be described in more detail through Examples. Since these Examples are only for illustrating the present disclosure, it will be apparent to those skilled in the art that the scope of the present disclosure should not be construed as being limited by the Examples.

### [Preparation Example 1] Preparation of Polyimide Resin Composition

A multi-component polyimide resin composition according to an embodiment of the present disclosure was synthesized through a two-step polymerization process using four different monomers as follows: 4,4′-(hexafluoroisopropylidene)diphthalic anhydride (6FDA) (99%, Changzhou Sunlight Pharmaceutical Co., Ltd.), 4,4′-(4,4′-isopropylidenediphenoxy)diphthalic anhydride (BISPDA) (98%, Tokyo Chemical Industry), 4,4′-dithioaniline (4AD) (98%, Tokyo Chemical Industry), and 4,7,10-trioxa-1,13-tridecanediamine (TTDA) (97%, Sigma-Aldrich). In this case, a total of five (5) compositions were prepared by fixing a molar ratio between a sum of the dianhydride-based monomers (6FDA and BISPDA) and a sum of the diamine-based monomers (4AD and TTDA) to 1:1, wherein a molar ratio of the 4AD and the TTDA was fixed to 1:4, and varying a molar ratio of the 6FDA and the BISPDA. Specifically, Example 1 is a composition (6B91) having the molar ratio of 6FDA and BISPDA of 9:1, Example 2 is a composition (6B41) having the molar ratio of 6FDA and BISPDA of 4:1, Example 3 is a composition (6B32) having the molar ratio of 6FDA and BISPDA of 3:2, Example 4 is a composition (6B14) having the molar ratio of 6FDA and BISPDA of 1:4, and Example 5 is a composition (6B19) having the molar ratio of 6FDA and BISPDA of 1:9.

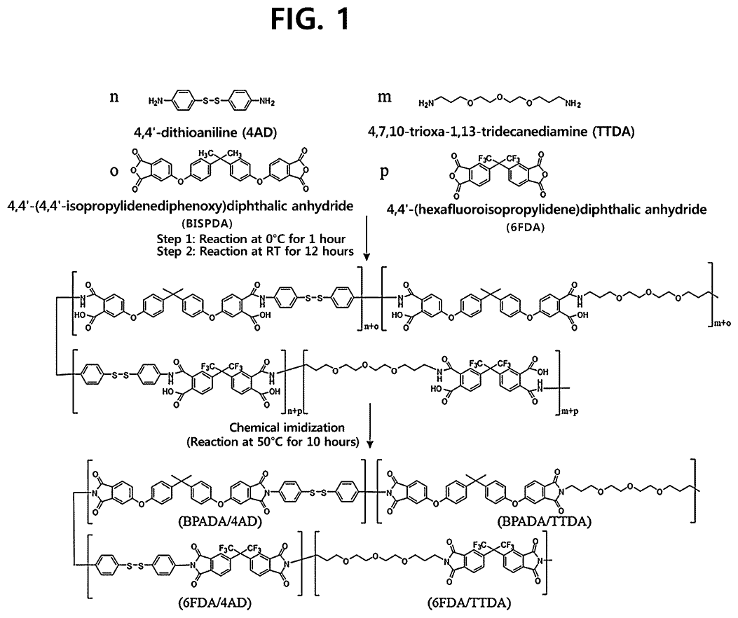

The synthesis was performed in a polar aprotic solvent of N,N-dimethylacetamide (DMAc, Daejung Chemical) having a total solid (monomer) content of 25 wt %. The diamine-based monomers (4AD and TTDA) (20 mmol in total) were added to each sample of the DMAc. The dianhydride-based monomers (6FDA and BISPDA) (20 mmol in total) were added to the solution. The solution was stirred at 0° C. for 1 hour, and then stirred in a nitrogen atmosphere at a room temperature overnight. The first reaction step was polyamic acid (PAA) reaction through ring dehydration, and the second reaction step was chemical imidization using pyridine and acetic anhydride. FIG. 1 schematically shows the synthesis steps used in this Example. The final reacted solution was precipitated in a methanol/deionized water-mixed solution and washed with ethanol. Each polyimide resin composition prepared after the washing step was dried at 70° C. for 12 hours to remove a residual solvent, and finally, a solid polyimide resin composition with a fibrous structure was obtained.

### [Preparation Example 2] Preparation of Polyimide Film

As an embodiment of the present disclosure, each of the solid polyimide resin compositions prepared by Examples 1 to 5 was dissolved in a DMAc solvent to a concentration of 25% by weight, and then air bubbles were removed from the solution under vacuum at a room temperature. Each composition from which the bubbles were sufficiently removed was spin-coated on a glass substrate to prepare a film. The spin coating was maintained for 10 seconds at a speed of 500 to 1000 rpm depending on the film thickness. The films (Examples 6 to 10) having a thickness ranging from 30 to 80 μm were obtained depending on a speed of the spin coater.

### [Comparative Example 1] Preparation of Three Components-Based Polyimide Film (6FDA14)

A 30 μm thick transparent polyimide film (6FDA14) was prepared in the same manner as in Preparation Examples 1 and 2, except that DMAc of 20 ml was put into a beaker of 100 ml, and 4,4′-(hexafluoroisopropylidene)diphthalic anhydride (6FDA) of 10 mmol (4.44g), TTDA monomer of 8 mmol (1.762 g) and 4AD of 8 mmol (0.496 g) were added therein and mixed.

### Test Example 1

The chemical structures of the polyimide resin compositions of Examples 1 to 5 prepared by Preparation Example 1 were analyzed at a resolution of 4 cm¹ using Fourier transform infrared spectroscopy (FT-TR, Nicolet iS10, Thermo Scientific) by performing 32 scans for each of Examples 1 to 5. Molecular weights of each synthesized polyimide were determined through a gel permeation chromatography (GPC, Thermo Scientific Ultimate 3000) with THF having a concentration of 1 mg/mL.

TABLE 1

| | | | | | Molar | |
|---|---|---|---|---|---|---|
| | Sample | Dianhydride | | Total molar ratio | weight | |
| | code | (6FDA:BISPDA) | Diamine(4AD:TTDA) | (dianhydride:diamine) | (10⁴ g/mol) | PDI |
| Example 1 | 6B91 | 18 mmol:2 mmol | 4 mmol:16 mmol | 1:1 | 8.1 | 2.57 |
| Example 2 | 6B41 | 16 mmol:4 mmol | 4 mmol:16 mmol | 1:1 | 7.7 | 2.49 |
| Example 3 | 6B32 | 12 mmol:8 mmol | 4 mmol:16 mmol | 1:1 | 5.4 | 2.54 |
| Example 4 | 6B14 | 4 mmol:16 mmol | 4 mmol:16 mmol | 1:1 | 2.8 | 2.46 |
| Example 5 | 6B19 | 2 mmol:18 mmol | 4 mmol:16 mmol | 1:1 | 1.2 | 2.22 |

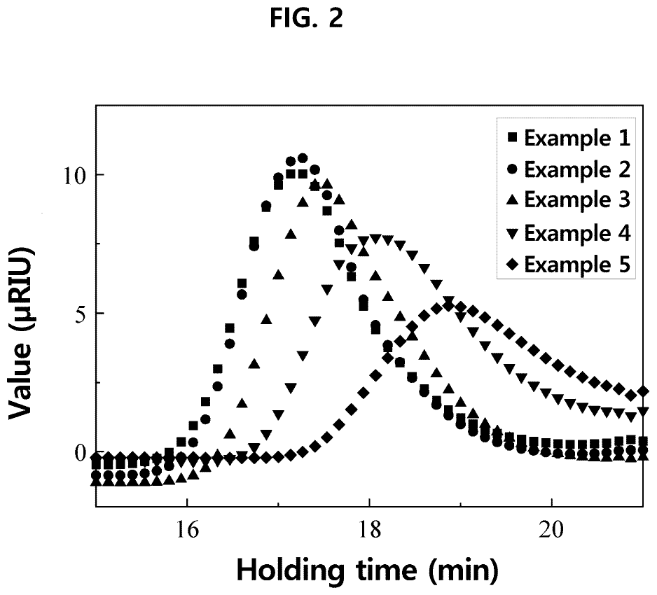

FIG. 2 shows the results of a gel permeation chromatography (GPC) of Examples 1 to 5, which indicates a tendency for the molecular weight to decrease as the content of 6FDA decreases. This is because a salt bridge is created due to a high basicity of TTDA in the polyamic acid (PAA) reaction step, which is the intermediate state during the composition synthesis process, and at this time, a high repulsion force of a trifluoromethyl group (—CF₃) of 6FDA causes increase in a distance between the molecules so that the molecular weight increases by suppressing formation of the salt bridge. However, as BISPDA content increases from Example 1 to Example 5 gradually, a low molecular weight is shown due to decrease in a proportion of the trifluoromethyl group (—CF₃). As a result, Example 5 (6B19), which had a large content of BISPDA, had a lower molecular weight decreased to 1.2×10⁴/mol. In addition, A transparency of the films of Examples 6 to 10 prepared by Preparation Example 2 was checked through UV-vis spectra and was shown in Table 2. In this case, the UV-vis spectra (Jasco V-670 UV-vis/NIR spectrophotometer) were obtained by transmittance and absorbance modes at 1 nm intervals between 200 and 800 nm. A thickness of the films used for measurement was 30 μm.

TABLE 2

| | Sample code | Transparency % (400 nm) |
|---|---|---|
| Example 6 | 6B91 | 96 |
| Example 7 | 6B41 | 96 |
| Example 8 | 6B32 | 97 |
| Example 9 | 6B14 | 98 |
| Example 10 | 6B19 | 96.5 |

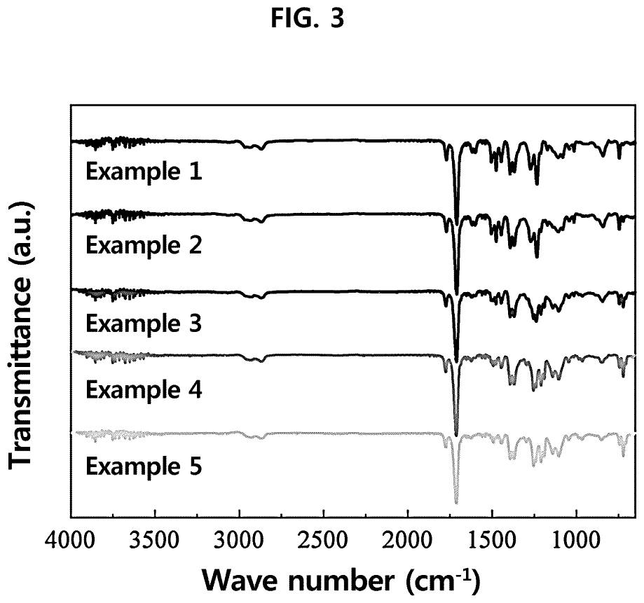

As a result, Examples 6 to 10 all showed transmittance of 90% or more at an absorbance wavelength of 500 nm or more. As the content of BISPDA increased, the onset point at which the transmittance increased was red shifted from 340 nm to 370 nm. This means that as a content of 6FDA in the polyimide resin film decreases, a bulky group such as the trifluoromethyl group (—CF₃) decrease so that the transparency increases due to decrease in a CTC (Charge Transfer Complex) effect, which is an intramolecular interaction. FIG. 3 shows the results of FT-IR spectra for structural analysis of the films of Examples 6 to 10 prepared by Preparation Example 2. In FIG. 3, the peak according to wave number (cm⁻¹) means the following:
1000 to 1250 (cm⁻¹): C—O stretch
1365 (cm⁻¹): Imide C—N—C
1500 (cm⁻¹): Aromatic C═C
1710, 1770 (cm⁻¹): C═O stretch
2870 to 2965 (cm⁻¹): C—H stretch

In all Examples, axial imide II C—N—C(1365 cm⁻¹), carbonyl in-plane and out-of-plane C═O stretch (1710 cm⁻¹ and 1770 cm⁻¹) bonds were good, which confirmed successful imidization, and methyl group sp³ CH₃ (2980-2960 cm⁻¹) was confirmed to appear due to the introduction of TTDA. In addition, as a content of BISPDA increased, the peak of phenol C—O (1220 cm⁻¹) tended to become more prominent, which was confirmed to be due to the ether bond (—C—O—C—) of BISPDA.

### Test Example 2

Prior to checking a self-healing property of the films of Examples 6 to 10 prepared by Preparation Example 2, a glass transition temperature (Tg) of each Example was analyzed by thermogravimetric analysis (TGA, Q50, TA Instruments, USA) and differential scanning calorimetry (DSC, Q20, TA Instruments, USA). Specifically, the thermogravimetric analysis was performed by heating 10 mg of each film of Examples 6 to 10 from 35° C. to 800° C. in a nitrogen atmosphere at a speed of 10° C./min. The DSC measurement was performed by, at a speed of 10° C./min, (1) heating from 35° C. to 300° C.; (2) cooling to 0° C.; and (3) repeating the steps (1) and (2). The Tg was determined from the second heating cycle. As a result, each Tg of Examples 6 to 10 was 95° C., 95° C., 85° C., 85° C., and 85° C.

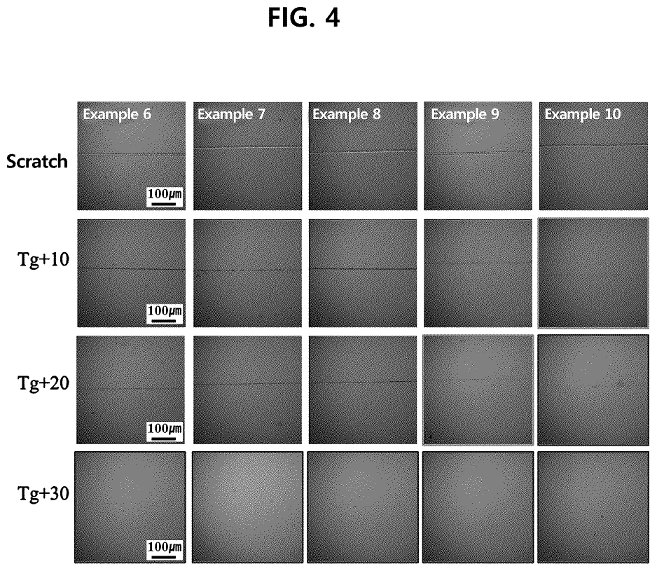

Next, as shown in FIG. 4, each of the films of Examples 6 to 10 was scratched using a single edge blade (DN-52, DORCO), and then a degree of self-healing was checked by photographing with an optical microscope (Olympus, SZX16 optical microscope). First, a self-healing temperature was set to Tg+10° C., Tg+20° C., and Tg+30° C. based on the glass transition temperatures (Tg) of Examples 6 to 10, and a self-healing time was set to 20 minutes.

As a result, in Examples 6 to 10, the self-healing was all completed under Tg+30° C. healing condition. Among them, the self-healing in Examples 9 and 10 was almost completed even at Tg+20° C., and the self-healing in Example 10 was partially completed even at Tg+10° C. This means that as a content of BISPDA increases the self-healing temperature decreases by the tendency of decrease in the glass transition temperature from 94° C. to 84° C. That is, according to an embodiment of the present disclosure, it was confirmed that the glass transition temperature was reduced by about 10° C., thereby improving mobility of polymer chains and resulting in the low self-healing temperature.

### Test Example 3

It was confirmed by Test Example 2 that all films of Examples 6 to 10 self-healed well in the range of Tg+30° C. However, since there were differences in the degree of self-healing of some Examples in the zones of Tg+10° C. and Tg+20° C., these differences were additionally compared through a mechanical property.

Specifically, the mechanical property of the films of Examples 6 to 10 was measured and analyzed at a load cell of 100N, a gauge length of 10 mm, and a crosshead speed of 5 mm/min according to the ASTM D638 test method, using a universal tensile machine (UTM, Instron model 5567A). A dogbone dumbbell specimen was used, wherein a dimension of the specimen was 30 (length) Y5 (width) Y10 (length of narrow part) Y1.5 (width of narrow part) Y0.03 (thickness) mm. A minimum of 10 samples were tested for each Example and averages of each set of measurements was used. The failure stress and the Young's modulus of the self-healed samples were obtained from the curves of stress-strain.

TABLE 3

| | | | Tensile | Elastic | Self- |
|---|---|---|---|---|---|
| | Sample | Self-healing | strength | modulus | healing |
| | code | condition | (Mpa) | (Mpa) | rate (%) |
| Exam- | 6B91 | Tg + 10° C., | 47.22 ± 6.26 | 2276 ± 130 | 65 |
| ple 6 | | 20 minutes | | | |
| | | Tg + 20° C., | 54.5 ± 11.7 | 2340 ± 110 | 75.5 |
| | | 20 minutes | | | |
| Exam- | 6B41 | Tg + 10° C., | 56.9 ± 11.1 | 2327.8 ± 107 | 78.1 |
| ple 7 | | 20 minutes | | | |
| | | Tg + 20° C., | 62.7 ± 8.8 | 2338 ± 110 | 86.1 |
| | | 20 minutes | | | |
| Exam- | 6B32 | Tg + 10° C., | 58.2 ± 6.1 | 2293 ± 100 | 80.6 |
| ple 8 | | 20 minutes | | | |
| | | Tg + 20° C., | 64.6 ± 14 | 2340 ± 80 | 89.1 |
| | | 20 minutes | | | |
| Exam- | 6B14 | Tg + 10° C., | 62 ± 5.6 | 2324 ± 129 | 82.5 |
| ple 9 | | 20 minutes | | | |
| | | Tg + 20° C., | 71.3 ± 3.3 | 2302.6 ± 104 | 95 |
| | | 20 minutes | | | |
| Exam- | 6B19 | Tg + 10° C., | 63.1 ± 8 | 2333.5 ± 237 | 82 |
| ple 10 | | 20 minutes | | | |
| | | Tg + 20° C., | 74.5 ± 2.3 | 2381 ± 140 | 96.7 |
| | | 20 minutes | | | |

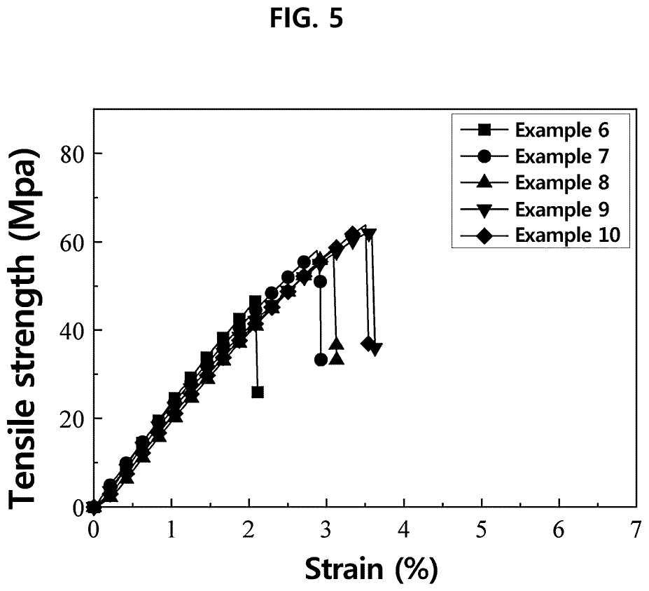

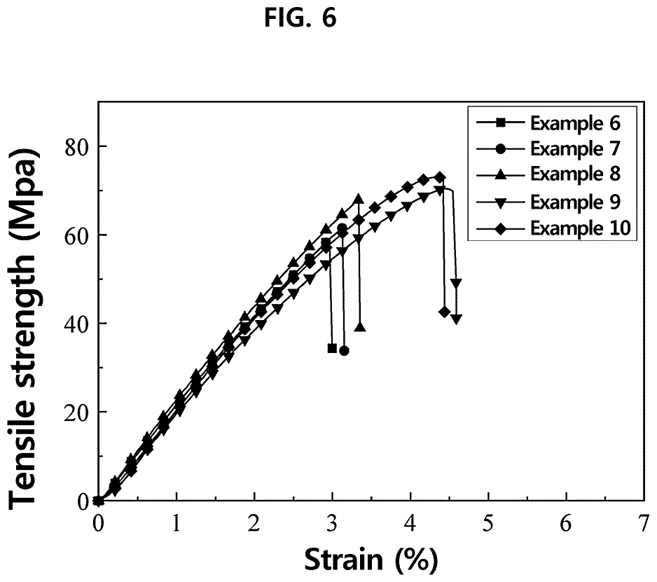

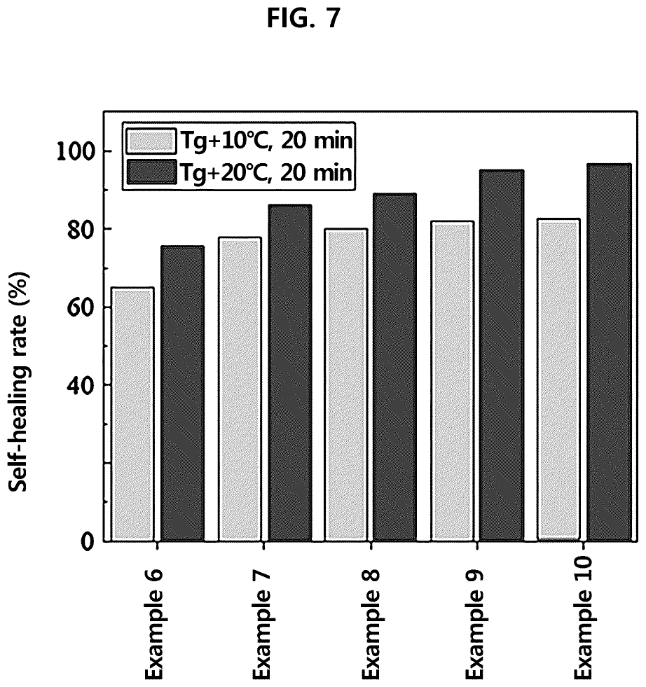

As a result, as shown in Table 3 and FIGS. 5 to 7, the self-healing rate of Example 6 with many —CF₃ functional groups was low to about 65% at the zone of Tg+10° C., but the self-healing rate of Examples 7 and 8 with reduced —CF₃ functional groups increased to about 80%. In particular, Examples 9 and 10 showed a high self-healing rate of about 85% at the zone of Tg+10° C. The self-healing rate of Examples 6 to 9 exhibited 75 to 89% at the zone of Tg+20° C., and the self-healing rate of Examples 9 and 10 reached over 95%. This is because the conventional three components-based polyimide resin film (Comparative Example 1) showed the self-healing rate of 95% or more at Tg+30° C. (125° C.), whereas the present disclosure showed the same result at Tg+20° C. (115° C.), which means that according to the present disclosure, a range of the self-healing temperature can be reduced by about 15%. In addition, the tensile strength of the conventional three components-based polyimide resin film was 57 MPa, whereas Example 2 of the present disclosure was found to be 24% higher than that of the conventional polyimide resin film, and as a content of BISPDA increased, the tensile strength and the elastic modulus increased. This is because the higher content of BISPDA causes increase in the mechanical strength due to increase in a benzene ring, and at the same time, the flexibility of the polymer increases due to decrease in the —CF₃ functional group and increase in the ether bond (—O—).

### Test Example 4

The following test was performed to analyze a dynamic behavior of the self-healing according to an embodiment of the present disclosure:

Specifically, the films of Examples 6 to 10 were scratched using a single edge blade (DN-52, DORCO), and then a scratch with a width of 30 μm was created at a speed of 1 N/min by applying a force of 1N through a scratch tester (Zest Co. Ltd., South Korea). After placing each scratched film on a glass substrate, a temperature of a hot plate (IKA, C-MAG HP 7) was raised to Tg+10° C., Tg+20° C., and Tg+30° C. on the basis of the glass transition temperature of each film prepared by Examples 6 to 10 to investigate a self-healing behavior of each film. In this case, the self-healing behavior of each film was analyzed at 0.1% strain, 3° C./min heating rate and 10 μm amplitude, using a rectangular sample size (6 (length)×7(width)×0.05(thickness) mm) by a dynamic mechanical analyzer (DMA, TA Instruments DMA Q800). Activation energy of the films was obtained from a tangent delta peak in multi-frequency mode (frequencies: 1, 3, 6, and 10 Hz), and the films were heated from 35° C. to 180° C. at a speed of 3° C./min. Time temperature superposition (TTS) plots were obtained through a frequency sweep, with the frequency being set from 100 Hz to 0.1 Hz and the temperature being set from 60° C. to 120° C.

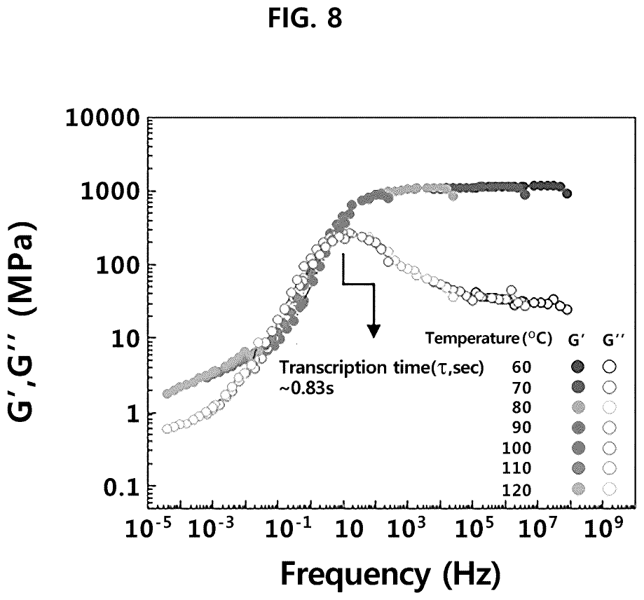

As a result, Examples 6 to 10 showed different self-healing efficiencies under the same self-healing condition. A reason why Examples 9 and 10 showed high self-healing efficiency was confirmed through a dynamic thermal analyzer. 6B14 and 6B19 of Examples 9 and 10 were able to self-heal in the tangent delta value range of 0.25, but the self-healing efficiency from Example 8 was well improved in the tangent delta value range of 1.0. This is because the mobility of Examples 9 and 10 was superior to that of other Examples, showing high self-healing efficiency in the lower mobility range. In addition, a starting point of the transition point was examined by obtaining a master curve of all samples through the frequency sweep, and it was found that the transition point becomes faster as a content of BISPDA increases (see FIG. 8).

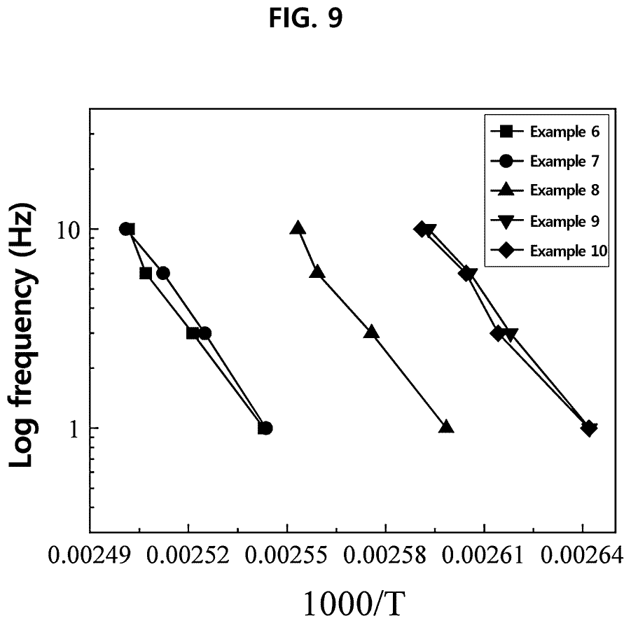

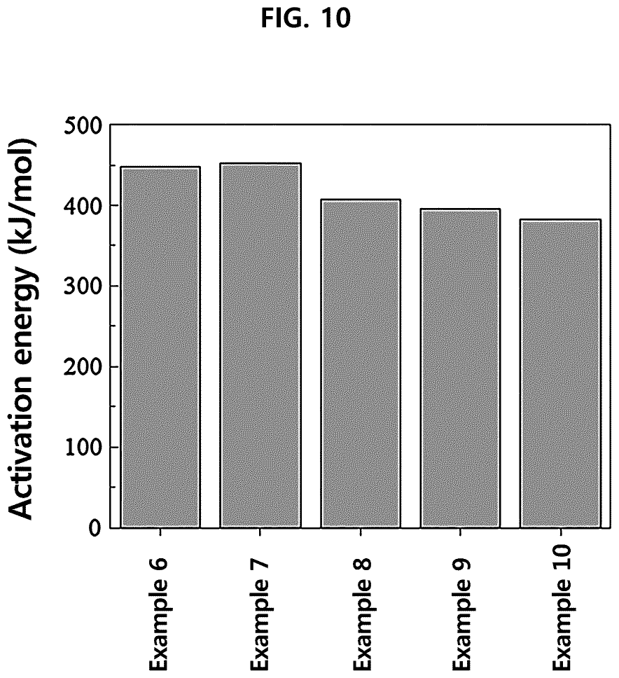

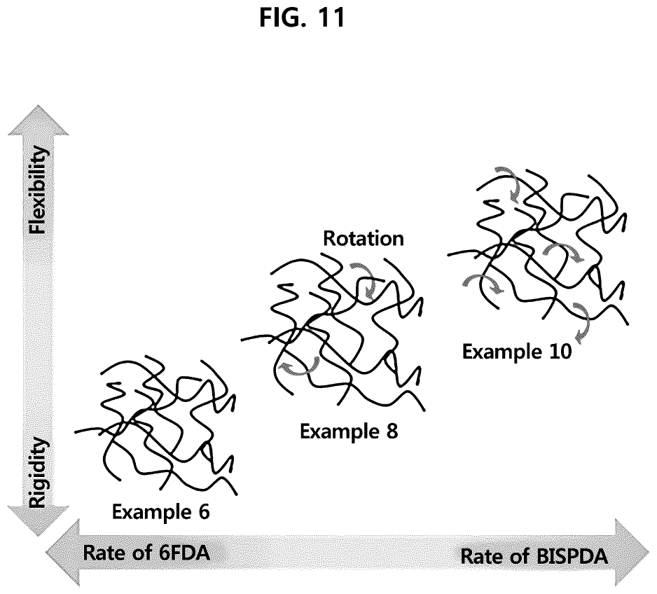

Further, in FIGS. 9 to 11, the activation energy was quantitatively calculated through an Arrhenius equation according to the frequency of how much energy is needed to reach the transition point. In Example 6, 450 kJ/mol of energy was required to reach the transition point, and the activation energy tended to decrease as a content of BISPDA increased. In Example 9, the energy was lowered to 390 kJ/mol, which is decreased up to about 14% compared to Example 6.

### Test Example 5

The following XRD (X-ray diffraction) test was performed to analyze the self-healing mechanism according to an embodiment of the present disclosure.

A force of 1N was uniformly applied to a surface of each film prepared by Examples 6 to 10 in an vertical direction thereof using a self-made scratch tester. In this case, a tool capable of creating scratches (blade, sandpaper, etc.) was attached to an end of the tip, and the scratches were created to a depth of about 30 μm with a speed of 1 N/min. Each of the films having the scratches was located on a hot plate (IKA, C-MAG HP 7), and a degree of change (restoring rate) of the created scratches was measured while changing the temperature condition to Tg+10° C., Tg+20° C., and Tg+30° C.

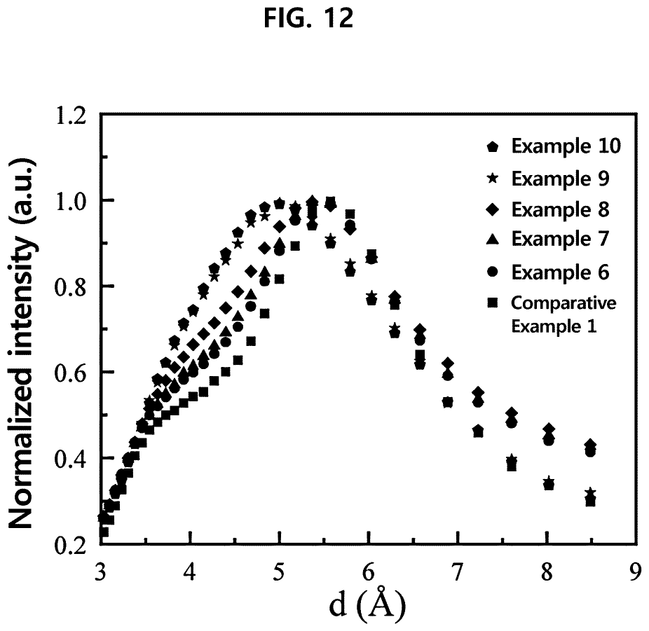

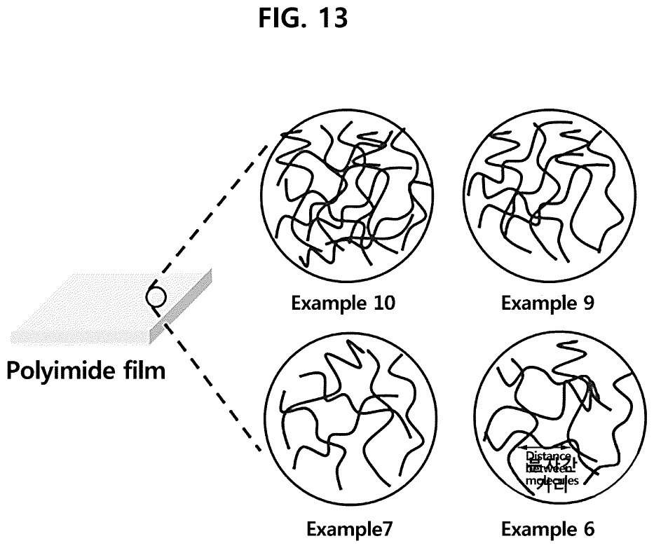

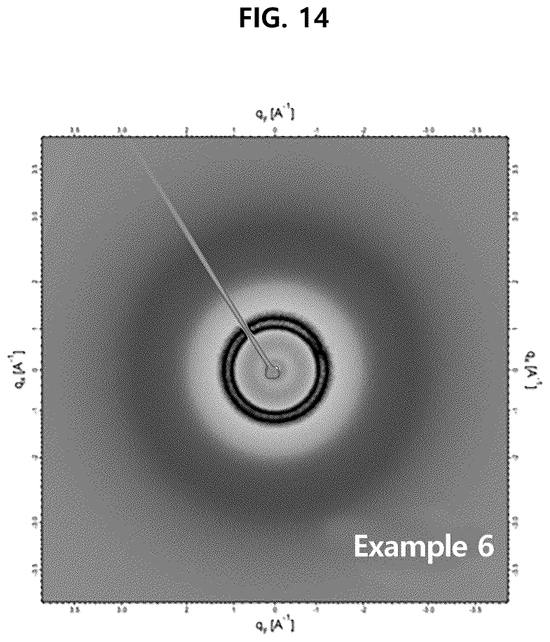

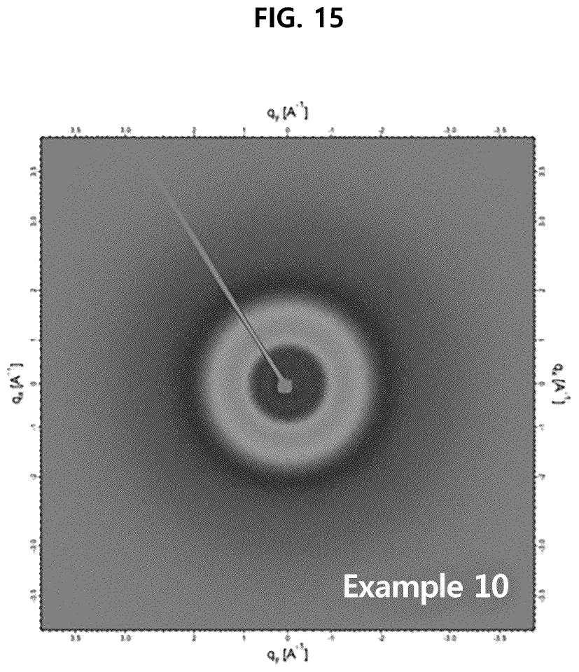

From the self-healing viewpoint, since interaction between the polymer chains is important for smooth self-healing, a distance between polymers may be an important factor. In Examples according to the present disclosure, contents of 6FDA and BISPDA vary depending on a ratio of the dianhydride. In Examples where a content of 6FDA is high, the distance between polymers may increase because a repulsion between the polymers increases due to a high electronegativity of the CF₃ functional group. However, as shown in FIGS. 12 to 15, in Examples 9 and 10, as a content of 6FDA decreased and a content of BISPDA increased, a distance between the polymer chains decreased from 6A to 5A due to decrease in a proportion of the CF₃ functional group, which shows that the distance between polymers was reduced by 17% compared to Comparative Example 1. This means that according to the present disclosure, since the distance between polymers is close, intermolecular interaction is possible more easily even under a low self-healing condition so that a high self-healing efficiency can be exhibited.

### Test Example 6

The following experiment was conducted to confirm that the film according to an embodiment of the present disclosure had an more improved effect than a conventional multi-component polyimide resin film by further comprising a dianhydride-based monomer containing an ether bond.

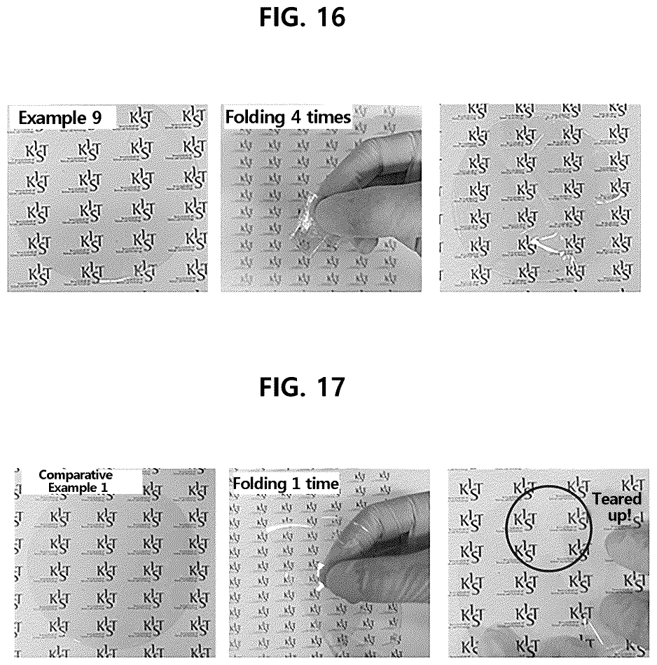

First, in order to confirm that the films of Examples according to the present disclosure have flexibility that does not tear even after repeated bending, the film of Example 9 and the film of Comparative Example 1 were folded and unfolded repeatedly. As a result, the film of Comparative Example 1 was torn when folded once (FIG. 16), but the film of Example 9 showed only slight wrinkles even when folded four times (FIG. 17), confirming that the mechanical strength was improved in both sides of the film.

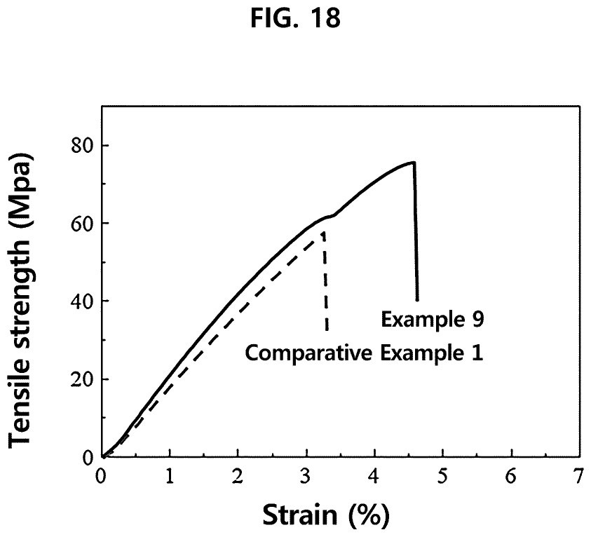

In order to quantitatively check this, a mechanical property of Example 9 and Comparative Example 1 was compared using the same method as described in Test Example 3. As a result, it was confirmed that as shown in FIG. 18, the elastic modulus of Example 9 was improved by about 15% from 2000 MPa to 2300 MPa and the tensile strength (MPa) was improved by about 31.5% from 57 MPa to 75 MPa, compared to those of Comparative Example 1.

### Test Example 7

The following experiment was performed to check whether the film prepared according to an embodiment of the present disclosure can be repeatedly recycled and reused.

First, the film of Example 9 was dissolved again in N,N-dimethylacetamide (DMAc, Daejung Chemical) as an organic solvent, for recycling, and then prepared again in a form of the film (Example 11) according to the method of Preparation Example 2 above. Next, the mechanical property of the film according to Example 9 before recycling and the film according to Example 11 prepared again after dissolving in the organic solvent was compared in the same method as Test Example 6.

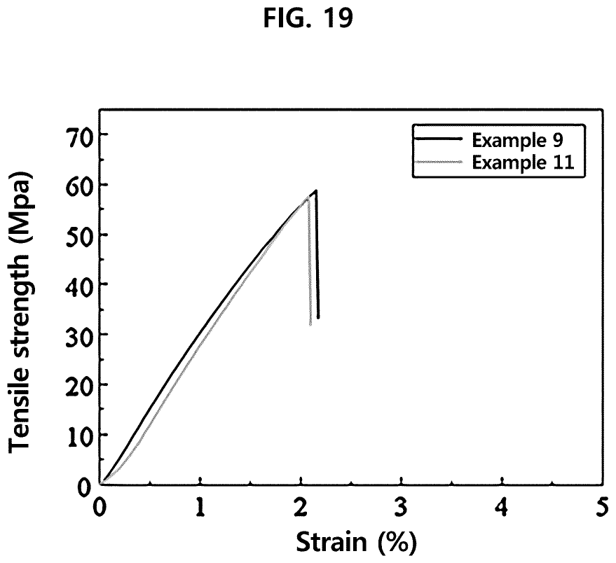

As a result, as shown in FIG. 19, the films of Example 9 and Example 11 were confirmed that the repeated recycling and reuse were possible by showing almost similar levels of the mechanical property.

In the above Examples, the present disclosure provided a multi-component polyimide with improved mechanical strength and a range of reduced self-healing temperature by designing a polymer structure combining four types of the monomers. The mechanical strength gradually increased depending on the polymer structure (tensile strength: 72 MPa˜77 MPa, E: ca. 2300 MPa), and the range of the self-healing temperature decreased from 125° C. to 100° C. This is because increase in a content of BISPDA, the dianhydride monomer containing the ether bond, caused enhancement of the mechanical strength due to increase in a content of the aromatic ring structure, and as the functional group of —CF₃ decreases, the flexibility is increased due to increase in the rotation and the mobility of the polymer chains. That is, according to the present disclosure, it can be confirmed that the trade-off relationship between the flexibility and the mechanical strength of the polymer chains has been improved. First, this shows that a flexible polyimide resin film can be prepared as a content of BISPDA increases by plotting the mobility relationship of polymer chains through a frequency sweep using a time-temperature superposition (TTS) to determine a dynamic relationship according to the polymer structure and quantitatively evaluating the mobility of the polymer through activation energy. Second, when examining a change in the distance between the polymer chains according to the constitutive components of the polymer through XRD, increase in the content of BISPDA caused decrease in the distance between polymer chains by 17%. This can be seen from the results confirming that, as described above, as a content of CF₃ having strong electronegativity is reduced, the distance between the polymer chains becomes closer to allow the self-healing more easily. Therefore, according to the present disclosure, it is possible to prove a self-healing polyimide resin composition that has stronger physical property and can self-heal in a lower temperature range, and a colorless and transparent polyimide film that can be repeatedly folded/bent and has a large area by using the self-healing polyimide resin composition.

The Examples of the present disclosure described above should not be construed as limiting the technical idea of the present disclosure. The protection scope of the present disclosure is limited only by the matters stated in the claims, and those skilled in the art can improve and change the technical idea of the present disclosure into various forms. Accordingly, such improvement and change will fall within the scope of protection of the present disclosure as long as they are obvious to those skilled in the art.

The present disclosure may provide the following embodiments as an example.

### Embodiment 1

A polyimide resin composition comprising:
a dianhydride-based monomer containing a trifluoromethyl group;
a dianhydride-based monomer containing an ether bond;
an aliphatic diamine-based monomer with a chain structure having 4 to 16 carbon atoms; and
an aromatic diamine-based monomer containing a disulfide bond;
wherein they are copolymerized with each other, and
wherein the main backbone or side backbone of the polyimide resin comprises a hydrogen bond and a disulfide bond.

### Embodiment 2

The polyimide resin composition according to the first embodiment,
wherein the dianhydride-based monomer containing the trifluoromethyl group is 4,4′-(hexafluoroisopropylidene)diphthalic anhydride (6FDA).

### Embodiment 3

The polyimide resin composition according to the first or second embodiment,
wherein the dianhydride-based monomer containing the ether bond is one or more selected from the group consisting of 4,4′-(4,4′-isopropylidenediphenoxy)diphthalic anhydride (BISPDA) and oxydiphthalic dianhydride (ODPA).

### Embodiment 4

The polyimide resin composition according to any one of the first to third embodiments,
wherein the aliphatic diamine-based monomer is one or more selected from the group consisting of 4,7,10-trioxa-1,13-tridecanediamine (TTDA), hexamethylenediamine, octamethylenediamine, decamethylenediamine, 2-methylpentamethylenediamine, 2-ethyltetramethylenediamine, 2-methyloctamethylenediamine, and trimethylhexamethylenediamine.

### Embodiment 5

The polyimide resin composition according to any one of the first to fourth embodiments,
wherein the aromatic diamine-based monomer is one or more selected from the group consisting of 4,4′-dithioaniline (4AD), 2,2′-dithioaniline, 2-hydroxyl disulfide, 3,3′-dithiodipropionic acid, 2,2′-(dithiodimethylene)difuran, 4-aminophenyl disulfide, 2,2′-diaminodiethyl disulfide dihydrochloride, and 3,3′-dihydroxydiphenyl disulfide.

### Embodiment 6

The polyimide resin composition according to any one of the first to fifth embodiments,

wherein the dianhydride-based monomer containing the trifluoromethyl group and the dianhydride-based monomer containing the ether bond are copolymerized with each other in a molar ratio of 1-9:1-9.

### Embodiment 7

The polyimide resin composition according to any one of the first to sixth embodiments,
wherein the aliphatic diamine-based monomer and the aromatic diamine-based monomer are copolymerized with each other in a molar ratio of 2 to 8:1.

### Embodiment 8

The polyimide resin composition according to any one of the first to seventh embodiments,
wherein a molar ratio of a sum of the aliphatic diamine-based monomer and the aromatic diamine-based monomer relative to a sum of the two types of dianhydride-based monomers is 10:5 to 15.

### Embodiment 9

The polyimide resin composition according to any one of the first to eighth embodiments,
wherein a weight average molecular weight of the polyimide resin composition is 10,000 to 100,000 g/mol and a polydispersity index (PDI) thereof is 3 or less.

### Embodiment 10

A polyimide film comprising the polyimide resin composition according to any one of the first to ninth embodiments.

### Embodiment 11

The polyimide film according to the tenth embodiment, further comprising a substrate onto which the polyimide resin composition is applied.

### Embodiment 12

The polyimide film according to the tenth or eleventh embodiment,
wherein a thickness of the polyimide film is 1 to 100 μm.

### Embodiment 13

The polyimide film according to any one of the tenth to twelfth embodiments,
wherein a light transmittance of the polyimide film is 90% or more at a wavelength range of 450 to 800 nm.

### Embodiment 14

The polyimide film according to any one of the tenth to thirteenth embodiments,
wherein the polyimide film exhibits a self-restoring rate of 75% or more at a temperature of 80 to 120° C.

### Embodiment 15

The polyimide film according to any one of the first to fourteenth embodiments,
wherein the film is a coating film or an adhesive film.

### Embodiment 16

An electronic device comprising the polyimide film according to any one of the tenth to fifteenth embodiments.

### Embodiment 17

The electronic device according to the sixteenth embodiment,
wherein the electronic device is any one selected from a display, a semiconductor, a transistor, a light emitting diode, and a laser device.

### Embodiment 18

A method for preparing the polyimide resin composition according to any one of the first to ninth embodiments, the method comprising the steps of:
adding an aliphatic diamine-based monomer with a chain structure of 4 to 16 carbon atoms, an aromatic diamine-based monomer containing a disulfide bond, a dianhydride-based monomer containing a trifluoromethyl group, and a dianhydride-based monomer containing a ether bond, into an organic solvent, and reacting them under an inert atmosphere to prepare a polyamic acid solution; and
carrying out imidization reaction of the polyamic acid solution to prepare the polyimide resin composition.

### Embodiment 19

The method for preparing the polyimide resin composition according to the eighteenth embodiment,
wherein the organic solvent is one or more selected from the group consisting of N,N-dimethylacetamide, N-methylpyrrolidone, N,N-dimethylformamide, N-vinylpyrrolidone, N-methylcaprolactam, dimethylsulfoxide, tetramethylurea, pyridine, dimethylsulfone, hexamethylsulfoxide, meta-cresol, gamma-butyrolactone, ethylcellosolve, butylcellosolve, ethylcarbitol, butylcarbitol, ethylcarbitol acetate, butylcarbitol acetate, ethylene glycol, ethyl lactate, butyl lactate, cyclohexanone, and cyclopentanone.

### Embodiment 20

The method for preparing the polyimide resin composition according to the eighteenth to nineteenth embodiments,
wherein the inert atmosphere is an atmosphere into which one or more inert gases selected from the group consisting of nitrogen, argon, hydrogen, helium, neon, xenon, and krypton are supplied.

### Embodiment 21

The method for preparing the polyimide resin composition according to any one of the eighteenth to twentieth embodiments,
wherein the imidization reaction comprises adding an imidization catalyst and a dehydrating agent to the polyamic acid solution.

### Embodiment 22

The method for preparing the polyimide resin composition according to any one of the eighteenth to twenty-first embodiments,
wherein the imidization catalyst is one or more of pyridine, isoquinoline, and beta-picoline.

### Embodiment 23

A method for preparing the polyimide film according to any one of the tenth to fifteenth embodiments, the method comprising the steps of:
preparing a polyimide resin composition according to the method described in any one of the eighteenth to twenty-first embodiments; and
coating the prepared polyimide resin composition on a substrate.

### Embodiment 24

The method for preparing the polyimide film according to the twenty-third embodiment,
wherein the coating is carried out by a bar coating, a spin-coating, a drop-casting, a dip-coating, a gravure roll coating, or an inkjet printing.

1. A polyimide resin composition comprising:
a dianhydride-based monomer containing a trifluoromethyl group;
a dianhydride-based monomer containing an ether bond;
an aliphatic diamine-based monomer with a chain structure having 4 to 16 carbon atoms; and
an aromatic diamine-based monomer containing a disulfide bond;
wherein they are copolymerized with each other, and
wherein the main backbone or side backbone of the polyimide resin comprises a hydrogen bond and a disulfide bond.

2. The polyimide resin composition according to claim 1, wherein the dianhydride-based monomer containing the trifluoromethyl group is 4,4′-(hexafluoroisopropylidene)diphthalic anhydride (6FDA).

3. The polyimide resin composition according to claim 1, wherein the dianhydride-based monomer containing the ether bond is one or more selected from the group consisting of 4,4′-(4,4′-isopropylidenediphenoxy)diphthalic anhydride (BISPDA) and oxydiphthalic dianhydride (ODPA).

4. The polyimide resin composition according to claim 1, wherein the aliphatic diamine-based monomer is one or more selected from the group consisting of 4,7,10-trioxa-1,13-tridecanediamine (TTDA), hexamethylenediamine, octamethylenediamine, decamethylenediamine, 2-methylpentamethylenediamine, 2-ethyltetramethylenediamine, 2-methyloctamethylenediamine, and trimethylhexamethylenediamine.

5. The polyimide resin composition according to claim 1, wherein the aromatic diamine-based monomer is one or more selected from the group consisting of 4,4′-dithioaniline (4AD), 2,2′-dithioaniline, 2-hydroxyl disulfide, 3,3′-dithiodipropionic acid, 2,2′-(dithiodimethylene)difuran, 4-aminophenyl disulfide, 2,2′-diaminodiethyl disulfide dihydrochloride, and 3,3′-dihydroxydiphenyl disulfide.

6. The polyimide resin composition according to claim 1, wherein the dianhydride-based monomer containing the trifluoromethyl group and the dianhydride-based monomer containing the ether bond are copolymerized with each other in a molar ratio of 1-9:1-9.

7. The polyimide resin composition according to claim 1, wherein the aliphatic diamine-based monomer and the aromatic diamine-based monomer are copolymerized with each other in a molar ratio of 2 to 8:1.

8. The polyimide resin composition according to claim 1, wherein a molar ratio of a sum of the aliphatic diamine-based monomer and the aromatic diamine-based monomer relative to a sum of the two types of dianhydride-based monomers is 10:5 to 15.

9. The polyimide resin composition according to claim 1, wherein a weight average molecular weight of the polyimide resin composition is 10,000 to 100,000 g/mol and a polydispersity index (PDI) thereof is 3 or less.

10. A polyimide film comprising the polyimide resin composition according to claim 1.

11. The polyimide film according to claim 10, further comprising a substrate onto which the polyimide resin composition is applied.

12. The polyimide film according to claim 10, wherein a thickness of the polyimide film is 1 to 100 μm.

13. The polyimide film according to claim 10, wherein a light transmittance of the polyimide film is 90% or more at a wavelength range of 450 to 800 nm.

14. The polyimide film according to claim 10, wherein the polyimide film exhibits a self-restoring rate of 75% or more at a temperature of 80 to 120° C.

15. The polyimide film according to claim 10, wherein the film is a coating film or an adhesive film.

16. An electronic device comprising the polyimide film according to claim 10.

17. The electronic device according to claim 16, wherein the electronic device is any one selected from a display, a semiconductor, a transistor, a light emitting diode, and a laser device.

18. The polyimide film according to claim 10, wherein the dianhydride-based monomer containing the trifluoromethyl group is 4,4′-(hexafluoroisopropylidene)diphthalic anhydride (6FDA).

19. The polyimide film according to claim 10, wherein the dianhydride-based monomer containing the ether bond is one or more selected from the group consisting of 4,4′-(4,4′-isopropylidenediphenoxy)diphthalic anhydride (BISPDA) and oxydiphthalic dianhydride (ODPA).

20. The polyimide film according to claim 10, wherein the aliphatic diamine-based monomer is one or more selected from the group consisting of 4,7,10-trioxa-1,13-tridecanediamine (TTDA), hexamethylenediamine, octamethylenediamine, decamethylenediamine, 2-methylpentamethylenediamine, 2-ethyltetramethylenediamine, 2-methyloctamethylenediamine, and trimethylhexamethylenediamine.

21-24. (canceled)
